(19) United States
(12) Patent Application Publication
(10) Pub. No.: US 2017/0286964 A1
(43) Pub. Date: Oct. 5, 2017

(54) Biometrics-based Recognition and Reward System and Method

(71) Applicant: Michael J. Emoff, Dayton, OH (US)

(72) Inventor: Michael J. Emoff, Dayton, OH (US)

(21) Appl. No.: 15/083,594

(22) Filed: Mar. 29, 2016

(51) Int. Cl. G06Q 20/40; G06Q 30/02

(52) U.S. Cl. CPC G06Q 20/40145; G06Q 30/0231

(57) ABSTRACT

A method for recognizing a first party by a second party and rewarding the first party for such recognition, the first party including at least one biometric identifier, the method including performing, by the first party, an action, determining, by the second party, whether the action performed by the first party is a recognizable action, when the action is a recognizable action, making an identification of the first party using the biometric identifier and, based on the identification, awarding the first party points through a rewards program platform.

### FIELD

This application relates, generally, to recognition and reward systems and methods and, more particularly, to recognition and reward systems and methods by which a company employee or other entity, such as a service supplier, may receive rewards, the value of which may, at least in part, depend on recognition of performance reported by the company's customers or by company supervisory personnel.

### BACKGROUND

Recognition and reward systems are used by supervisors or customers to reward points for beneficial behavior exhibited by employees. The reward points accumulated by employees may be “cashed in” for lifestyle awards or products, such as gift cards, apparel or the like, that have been made available to the employee by the company or a rewards management company that has contracted with the company. Therefore, recognition and reward systems provide employees with an incentive to perform their duties in accordance with company directives.

For example, U.S. Pat. No. 8,608,062 issued on Dec. 17, 2013, discloses a recognition and reward system in which a first party (e.g., an employee) physically carries an identification assembly having at least one identification code and a second party (e.g., a customer or supervisor) physically carriers a reader assembly. The reader assembly collects data from the identification code on the identification assembly, such as by radio frequency identification, thereby effecting a recognition and the issuance of a reward (redeemable points).

Despite the existence of certain recognition and reward systems, those skilled in the art continue with research and development efforts in the field of recognition and reward systems and methods.

### SUMMARY

In one embodiment, disclosed is a method for recognizing a first party by a second party and rewarding the first party for such recognition, the first party including at least one biometric identifier. The method may include (1) performing, by the first party, an action; (2) determining, by the second party, whether the action performed by the first party is a recognizable action; (3) when the action is a recognizable action, making an identification of the first party using the biometric identifier; and (4) based on the identification, awarding the first party points through a rewards program platform.

In another embodiment, disclosed is a system for recognizing a first party by a second party and rewarding the first party for such recognition, the first party including at least one biometric identifier. The system may include a biometric reader device carried by the second party, the biometric reader device being configured to collect data indicative of the biometric identifier, and a rewards program platform selectively interfaceable with the biometric reader device to receive the data collected by the biometric reader device, wherein the rewards program platform awards redeemable points to the first party based on the data collected by the biometric reader device.

Other embodiments of the disclosed biometrics-based recognition and reward system and method will become apparent from the following description, the accompanying drawings and the appended claims.

### BRIEF DESCRIPTION OF THE DRAWINGS

FIG. 1 is a schematic illustration of one embodiment of the disclosed biometrics-based recognition and reward system;

FIG. 2 is a block diagram of a biometric reader device of the biometrics-based recognition and reward system of FIG. 1;

FIG. 3 is a plan view of a smartphone embodying the biometric reader device of FIG. 2;

FIG. 4 is a schematic illustration of another embodiment of the disclosed biometrics-based recognition and reward system; and

FIG. 5 is a flow diagram depicting one embodiment of the disclosed biometrics-based recognition and reward method.

### DETAILED DESCRIPTION

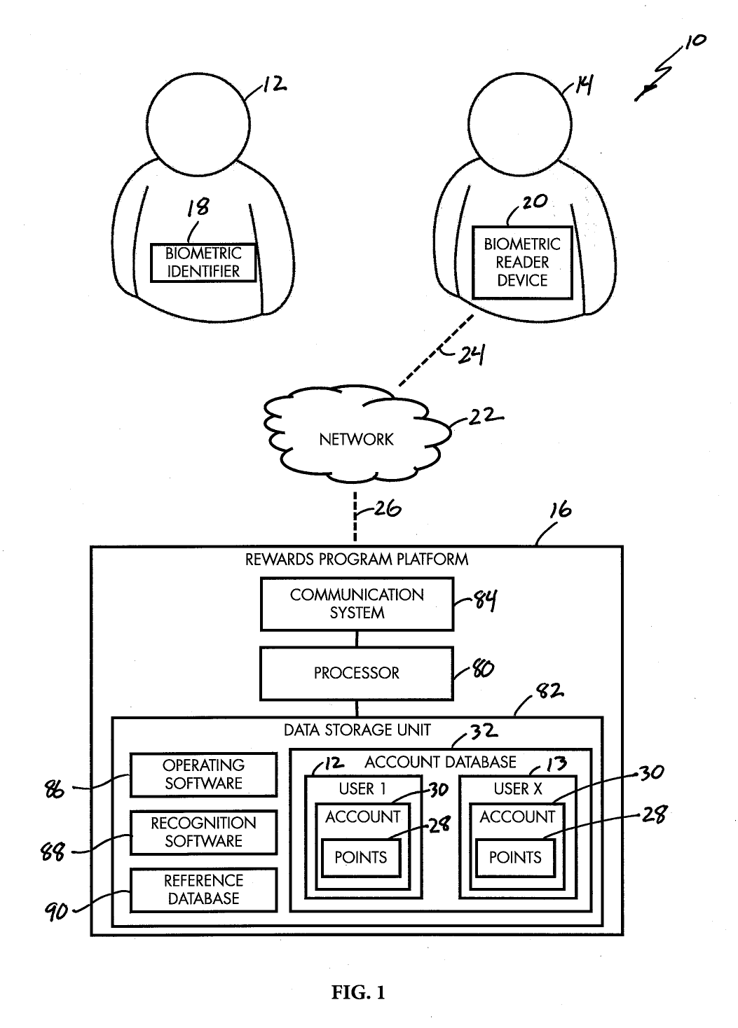

Referring to FIG. 1, one embodiment of the disclosed biometrics-based recognition and reward system, generally designated 10, may include a first party 12, a second party 14 and a rewards program platform 16. The first party 12 may have at least one biometric identifier 18. The second party 14 may carry a biometric reader device 20 capable of reading the biometric identifier 18 of the first party 12. The biometric reader device 20 may be in communication with the rewards program platform 16 over a network 22, such as the Internet, a local area network (LAN), a wide area network (WAN), a telecommunications network (e.g., a cellular network) or the like. Therefore, communication between the biometric reader device 20 and the rewards program platform 16 may be wireless (see wireless communication lines 24, 26) and either one-way or two-way.

The disclosed biometrics-based recognition and reward system 10 may be used to recognize the first party 12 by the second party 14. For example, when the first party 12 performs an action and the second party 14 determines that such action is a recognizable action, then the second party 14 may use the disclosed biometrics-based recognition and reward system 10 to effect recognition of the first party 12.

As used herein, a “recognizable action” may be any action performed by the first party 12 that warrants recognition and/or reward. A list of recognizable actions may be pre-defined, such as by an employer intending to promote certain actions by its employees or a company intending to promote certain actions by its customers. Examples of recognizable actions include, but are not limited to, the rendering of exceptional service, the delivery of exceptional work product, meeting or exceeding a performance standard, meeting a health or wellness milestone, meeting a time-of-service milestone, spending a certain amount of money and/or making a certain number of visits/interactions.

To recognize the first party 12, the second party 14 may use the biometric reader device 20 to collect data indicative of the biometric identifier 18 of the first party 12. This collected data may be used—by the biometric reader device 20, the rewards program platform 16 or otherwise—to make a biometric identification of the first party 12. The rewards program platform 16 may then award redeemable points 28 to the first party 12 based on the data collected by the biometric reader device 20, such as by crediting an appropriate quantity of points 28 to an account 30 associated with the first party 12 and maintained in an account database 32 on the rewards program platform 16.

Thus, the process of collecting data indicative of the biometric identifier 18 of the first party 12 may memorialize a recognition of the first party 12 (the recognized party) by the second party 14 (the recognizing party), and may result in the awarding of points 28 to the first party 12 thought the rewards program platform 16. Such points 28, either alone or in combination with previously awarded points, may entitle the first party 12 to a reward.

The points 28 may be redeemed for a reward, such as money, goods and/or services. To facilitate redemption of points 28, the points 28 may have a value, and may be redeemed per a pre-defined exchange rate. As one example, each point 28 may have a value of $1.00. As another example, each point 28 may have a value that is greater than $1.00. As yet another example, each point 28 may have a value that is less than $1.00.

The first party 12 may be the recognized party and the second party 14 may be the recognizing party. Therefore, the role of the first party 12 vis-à-vis the second party 14 will depend on the setting in which the disclosed biometrics-based recognition and reward system 10 is implemented. As one example, the first party 12 may be an employee and the second party 14 may be an employer of the first party 12. As another example, the first party 12 may be an employee and the second party 14 may be a supervisor of the first party 12. As another example, the first party 12 may be an employee and the second party 14 may be a co-worker of the first party 12. As another example, the first party 12 may be an employee and the second party 14 may be a customer. As yet another example, the first party 12 may be a customer and the second party 14 may be a company selling goods and/or services to the first party 12 (e.g., through an employee of the company).

The disclosed biometrics-based recognition and reward system 10 may employ one or more biometric identifiers 18 to facilitate the biometric identification of the first party 12. Various biometric identifiers 18 may be used without departing from the scope of the present disclosure. As one example, the biometric identifier 18 is a facial feature, and biometric identification is accomplished by facial recognition. As another example, the biometric identifier 18 is a finger print, and biometric identification is accomplished by fingerprinting. As another example, the biometric identifier 18 is a retina pattern, and biometric identification is accomplished by retina scan. As another example, the biometric identifier 18 is a palm print. As another example, the biometric identifier 18 is a hand geometry. As another example, the biometric identifier 18 is a vein pattern. As yet another example, the biometric identifier 18 is an iris pattern.

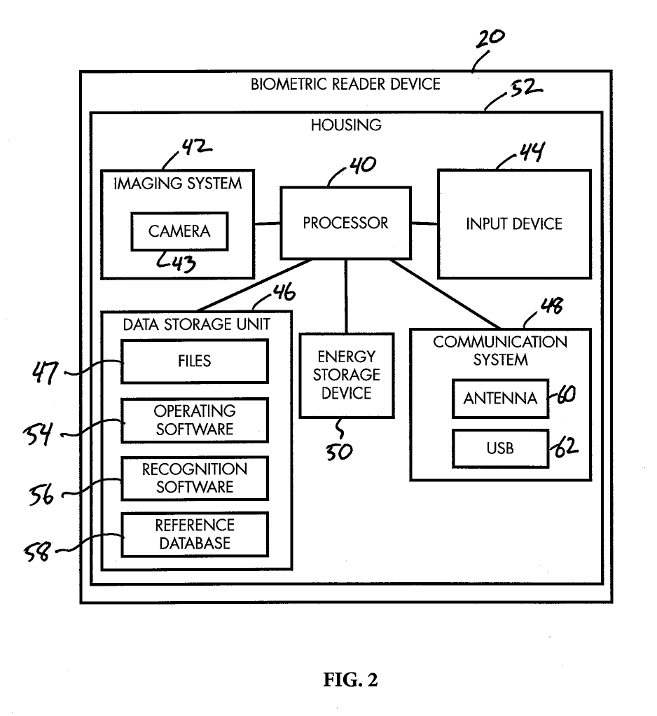

The biometric reader device 20 may be any apparatus capable of reading one or more biometric identifiers 18 of the first party 12, optionally storing data indicative of the biometric identifier 18 in a local storage medium (data storage unit 46 in FIG. 2) and communicating with the rewards program platform 16. While only one biometric reader device 20 is shown in FIG. 1, the disclosed biometrics-based recognition and reward system 10 may include additional biometric reader devices 20 carried by additional parties, without departing from the scope of the present disclosure. For example, a business may provide each supervisor with a biometric reader device 20 such that the supervisors may memorialize various acts (e.g., the rendering of good service) of employees by collecting data with the biometric reader devices 20.

Referring to FIG. 2, in one expression, the biometric reader device 20 may include a processor 40, an imaging system 42, an input device 44, a data storage unit 46 (e.g., random access memory (RAM), read only memory (ROM), solid state memory or the like), a communication system 48, and an energy storage device 50 (e.g., a super capacitor or a disposable battery). A housing 52, such as a plastic housing, may enclose (at least partially) the various components of the biometric reader device 20.

The biometric reader device 20 may be activated by way of the input device 44 (e.g., a button, a switch or a touchscreen), thereby supplying electrical power from the energy storage device 50 to the processor 40. Once activated, the processor 40 may direct the imaging system 42 to take a reading, which may result in the collection of data indicative of the biometric identifier 18 (FIG. 1) of the first party 12 (FIG. 1). For example, the imaging system 42 may include a camera 43, and taking a reading may include capturing an image (image data) of the biometric identifier 18.

The data collected by the imaging system 42 of the biometric reader device 20 may be encoded with a date and time stamp and stored as a file 47 in data storage unit 46. Data storage unit 46 may also contain operating software 54 used by the processor 40. Optionally, data storage unit 46 may also contain recognition software 56 and a reference database 58, thereby enabling the biometric reader device 20 to make an identification of the first party 12 (FIG. 1) by comparing (using recognition software 56) the data indicative of the biometric identifier 18 (FIG. 1) of the first party 12, as collected by the imaging system 42, to reference data (e.g., reference images, such as reference facial images) contained within the reference database 58.

The files 47 stored in data storage unit 46 of the biometric reader device 20 (and/or the identification made by the biometric reader device 20) may be retrieved by downloading the files 47 from the biometric reader device 20 to the rewards program platform 16 (FIG. 1) by way of the communication system 48 of the biometric reader device 20. As one example, the communication system 48 may include an antenna 60 that facilitates wireless data transmission (e.g., short wavelength radio transmission, such BLUETOOTH brand wireless technology) from the biometric reader device 20 to the rewards program platform 16. As another example, the communication system 48 may include a USB port 62 or the like that facilitates wired (e.g., by way of a computer) data transmission from the biometric reader device 20 to the rewards program platform 16.

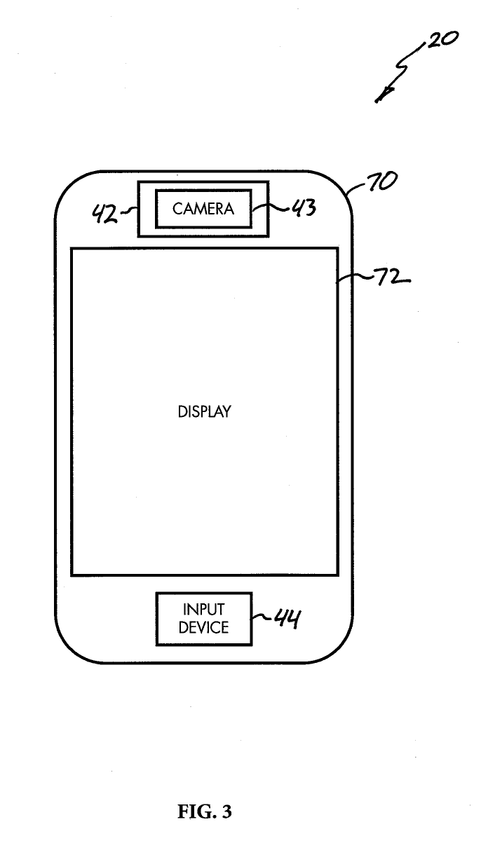

In one particular implementation, the biometric reader device 20 may be a mobile electronic device, such as a mobile telephone, a smartphone (e.g., an iPhone), a computer tablet (e.g., an iPad), a smart watch or an optical head-mounted display. As shown in FIG. 3, a smartphone 70 may include a display 72, an imaging system 42 that includes a camera 43, and an input device 44. Therefore, the smartphone 70 may function as a biometric reader device 20, and may be capable of reading, for example, facial features, fingerprints, palm prints, hand geometry, vein patterns, iris patterns, among other possible biometric identifiers 18 (FIG. 1). An application (i.e., an “app”) downloaded to the mobile electronic device (e.g., smartphone 70) may enable the mobile electronic device to function as the biometric reader device 20, and may coordinate communication with the rewards program platform 16 over the network 22 (FIG. 1).

Referring back to FIG. 1, the rewards program platform 16 may include a processor 80, a data storage unit 82 and a communication system 84. The processor 80 may comprise any type of technology. For example, the processor 80 may comprise a general-purpose server. Other types of servers and processing unit technologies are possible.

The communication system 84 may facilitate communication between the biometric reader device 20 and the rewards program platform 16. For example, the communication system 84 may include an antenna that facilitates wireless communication with the biometric reader device 20. Wired communication is also contemplated.

Data storage unit 82 may comprise any type of technology. For examples, data storage unit 82 may comprise random access memory (RAM), read only memory (ROM), solid state memory, or any combination thereof. Other types of memories and data storage unit technologies are possible.

Data storage unit 82 may contain operating software 86 that may be used by the processor 80 to maintain the account database 32, including updating the respective accounts 30 of users 12, 13 as the users 12, 13 accumulate and redeem points 28. Optionally, data storage unit 82 may also contain recognition software 88 and a reference database 90, thereby enabling the processor 80 to make an identification of the first party 12 by comparing (using recognition software 88) the data indicative of the biometric identifier 18 of the first party 12, as collected by the biometric reader device 20 and communicated to the rewards program platform 16, to reference data (e.g., reference images, such as reference facial images) contained within the reference database 90.

Thus, redeemable points 28 may be automatically added to the account 30 of the first party 12 (within account database 32) when an action performed by the first party 12 is recognized by the second party 14 as a recognizable action and the second party 14 uses the biometric reader device 20 to read the biometric identifier 18 of the first party 12. The first party 12 may then redeem points 28 in accordance with the rules associated with the rewards program platform 16.

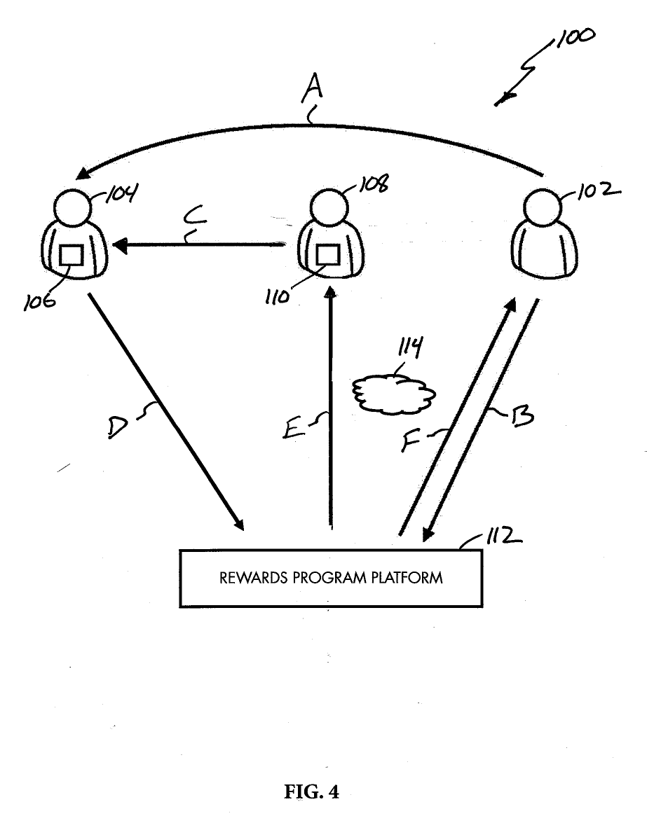

Another embodiment of the disclosed biometrics-based recognition and reward system is shown in FIG. 4 and generally designated 100. An employer 102 may provide to a customer and/or supervisor 104 a biometric reader device 106, as shown by arrow A. Furthermore, the employer 102 may have an employee 108, and the employee 108 may have at least one biometric identifier 110. The employer 102 may provide (or may contract with a third party to provide) a rewards program platform 112, such as a software-based (e.g., web software-based) rewards program platform 112. The employer 102 may identify (e.g., by name or number) to the rewards program platform 112 the customers/supervisors 104 and employees 108 participating in the recognition and reward system 100, as shown by arrow B.

The employer 102 may define a list of recognizable actions that warrant recognition and the awarding of points. The customers/supervisors 104 may be instructed that employees 108 may be rewarded when an action performed by an employee 108 qualifies as a recognizable action. The customers/supervisors 104 may also be instructed to use the biometric reader device 106 to take a reading of the biometric identifier 110 of an employee 108 when that employee performs an action that qualifies as a recognizable action. Therefore, as shown by arrow C, a customer/supervisor 104 may recognize an employee 108 by taking a reading of the biometric identifier 110 of the employee 108.

The data collected by the biometric reader device 106 may be communicated to the rewards program platform 112, as shown by arrow D. As one example, the data collected by the biometric reader device 106 may be automatically and wirelessly communicated to the rewards program platform 112 over a network 114. As another example, the customer/supervisor 104 must take certain steps (e.g., connect the biometric reader device 106 to a computer (not shown)) before the data collected by the biometric reader device 106 is communicated to the rewards program platform 112.

The rewards program platform 112 may compile the collected data, and may issue (arrow E) the employee 108 redeemable points based on, for example, the amount of recognition data collected regarding the employee 108. The points awarded to the employee 108 may be accumulated in an account maintained on the rewards program platform 112 until the points are redeemed by the employee 108 for various rewards (e.g., gift cards, products marked with the employer's logo or the like) made available to the employee 108 by the rewards program platform 112.

Furthermore, as shown by arrow F, the rewards program platform 112 may provide the employer 102 with a list of customers/supervisors 104 that have recognized employees 108, as well as a list of employees 108 that have received recognition from customers/supervisors 104.

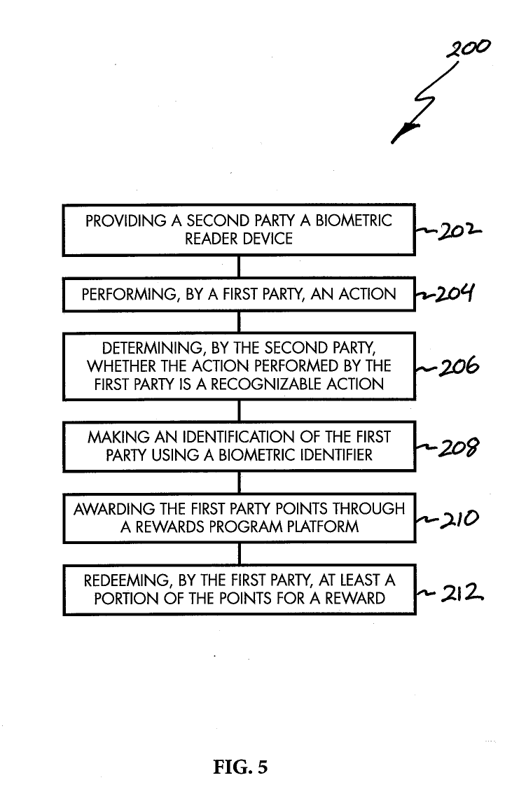

Also disclosed is a biometrics-based recognition and reward method. Referring to FIG. 5, one embodiment of the disclosed biometrics-based recognition and reward method, generally designated 200, may be used to recognize and reward a first party. The first party may include at least one biometric identifier, such as a fingerprint, a palm print, a hand geometry, a vein pattern, an iris pattern, a retina pattern and a facial feature.

At Block 202, a second party may be provided a biometric reader device (see, for example, the biometric reader device 20 in FIG. 1). The biometric reader device may be any device capable of reading at least one biometric identifier of the first party.

At Block 204, the first party may perform an action. As one example, the action may be performed by the first party in connection with the employment of the first party. As another example, the action may be performed by the first party in connection with the exchange of goods and/or services.

At Block 206, the second party may determine whether the action performed by the first party is a recognizable action that warrants recognition and/or reward. Examples of recognizable actions include, but are not limited to, the rendering of exceptional service, the delivery of exceptional work product, meeting or exceeding a performance standard, meeting a health or wellness milestone, meeting a time-of-service milestone, spending a certain amount of money and/or making a certain number of visits/interactions.

At Block 208, the first party may be identified using the second party's biometric reader device to read at least one biometric identifier of the first party. The data collected by the biometric reader device may be processed, whether by the biometric reader device itself or otherwise (e.g., by a rewards program platform), to ascertain the identity of the first party (a biometric identification).

At Block 210, the first party may be awarded redeemable points. The points may be added to an account maintained for the first party in an account database of an awards program platform.

At Block 212, the first party may redeem at least a portion of the first party's points for a reward. For example, the first party may be issued a reward (e.g., a gift card) in exchange for debiting a certain number of points from the account maintained for the first party in the account database of the awards program platform.

Accordingly, the disclosed biometrics-based recognition and reward system and method may provide a quick and efficient way to recognize and reward people, such as employees, customers and the like.

Although various embodiments of the disclosed biometrics-based recognition and reward system and method have been shown and described, modifications may occur to those skilled in the art upon reading the specification. The present application includes such modifications and is limited only by the scope of the claims.

What is claimed is:

1. A method for recognizing a first party by a second party and rewarding said first party for such recognition, said first party comprising at least one biometric identifier, said method comprising the steps of:
performing, by said first party, an action;
determining, by said second party, whether said action performed by said first party is a recognizable action;
when said action is said recognizable action, making an identification of said first party using said biometric identifier; and
based on said identification, awarding said first party points through a rewards program platform.

2. The method of claim 1 wherein said determining comprises determining whether said action performed by said first party is at least one of a plurality of recognizable actions.

3. The method of claim 1 further comprising the step of providing said second party a biometric reader device, wherein said identification is made using said biometric reader device.

4. The method of claim 3 wherein said biometric reader device comprises a camera.

5. The method of claim 3 wherein said biometric reader device is a mobile electronic device.

6. The method of claim 5 wherein said mobile electronic device is a smartphone.

7. The method of claim 1 wherein said identification of said first party is made using facial recognition.

8. The method of claim 1 wherein said biometric identifier comprises at least one of a fingerprint, a palm print, a hand geometry, a vein pattern, an iris pattern, a retina pattern and a facial feature.

9. The method of claim 1 wherein said awarding step comprises adding said points to previously awarded points, said points and said previously awarded points being accumulated in an account maintained on said rewards program platform for said first party.

10. The method of claim 1 further comprising the step of redeeming, by said first party, at least a portion of said points for a reward.

11. The method of claim 1 wherein said first party is an employee of a company and said second party is a customer of said company.

12. The method of claim 1 wherein said first party is an employee of a company and said second party is a supervisor of said employee.

13. A system for recognizing a first party by a second party and rewarding said first party for such recognition, said first party comprising at least one biometric identifier, said system comprising:
a biometric reader device carried by said second party, said biometric reader device being configured to collect data indicative of said biometric identifier; and
a rewards program platform selectively interfaceable with said biometric reader device to receive said data collected by said biometric reader device, wherein said rewards program platform awards redeemable points to said first party based on said data collected by said biometric reader device.

14. The system of claim 13 wherein said biometric reader device is a mobile electronic device.

15. The system of claim 14 wherein said mobile electronic device is a smartphone.

16. The system of claim 13 wherein said rewards program platform is selectively interfaceable with said biometric reader device over a wireless network.

17. The system of claim 13 wherein said biometric identifier comprises at least one of a fingerprint, a palm print, a hand geometry, a vein pattern, an iris pattern, a retina pattern and a facial feature.

18. The system of claim 13 further comprising a biometric identification system comprising:
reference data; and
a processor configured to compare said data collected by said biometric reader device with said reference data.

19. The system of claim 18 wherein said biometric identification system is associated with said rewards program platform.

20. The system of claim 13 wherein said first party is an employee of a company and said second party is a supervisor of said employee.
